(19) United States
(12) Patent Application Publication
(10) Pub. No.: US 2003/0158963 A1
(43) Pub. Date: Aug. 21, 2003

(54) Smartbridge for tactical network routing applications

(76) Inventors: James T. Sturdy, Albuquerque, NM (US); Curtis G. Cromwell, Albuquerque, NM (US)

Correspondence Address: Honeywell International Inc., Law Department, M/S AB2, Morristown, NJ, 07962, US

(21) Appl. No.: 10/080,310

(22) Filed: Feb. 20, 2002

(51) Int. Cl. G06F 15/173

(52) U.S. Cl. 709/238

(57) ABSTRACT

An intelligent communications capability that enhances legacy military tactical datalink systems by creating an interface between disparate civil and military communications systems onboard military aircraft, ground vehicles, and ground-based communications infrastructures. This capability performs various information management tasks to interface with avionics systems, ground vehicle computer systems, and ground-based infrastructure computer systems. The invention enhances message processing through automation in areas such as data collection, incoming message handling, outgoing message construction, communications network management, and message priority management and routing. The invention also incorporates learning techniques to improve the overall efficiency of integrated military missions, operations, and maintenance in areas such as intelligent consolidation of datalink information, intelligent message distribution, and adaptive message re-routing in response to communications network failures. These enhancements will benefit the military by improving mission effectiveness with real-time information integration and management while reducing their support costs.

### BACKGROUND OF THE INVENTION

1. Field of the Invention (Technical Field)

The invention relates to datalink communications for aircraft, spacecraft, surface vehicles, and ground-based communications infrastructures, and more particularly to a method and apparatus for an intelligent communications capability that enhances legacy military tactical datalink systems by creating an interface between disparate civil and military communications systems.

2. Background Art

Each military tactical datalink radio is an independent system and was not designed with the idea of integrating with other radio systems. In the past use of an external communications management router for military tactical datalink radios had not been developed. Until recently, the military was focused on specific tactical radio point solutions rather than an integrated solution.

The military is in the process of addressing requirements in order to use civil airspace, and at the same time is developing and expanding tactical radios and datalink systems to use in the digital battlefield. Unfortunately, the Radio Frequency (RF) spectrum, communications radio equipment, and message protocol requirements used in civil airspace operations [civil satellite radios, Very High Frequency (VHF) radios, High Frequency, (HF) radios, and wireless systems] are different from those used in digital battlefield operations [military satellite radios, Ultra High Frequency (UHF) radios, and HF radios]. This is further complicated by constraints on some military tactical aircraft and ground vehicles that only have tactical datalink systems with no provisions for the installation and use of civil communications equipment. Military ground-based communications infrastructures also lack the integration with civil infrastructures that could provide exchange of data between these systems.

Datalink communications include RF radio equipment operating in various frequency ranges (i.e. UHF, VHF, HF), as well as the associated communications networks and protocols [i.e. Aircraft Communications Addressing and Reporting System (ACARS), Aeronautical Telecommunications Network (ATN), Link-16]. Both civil datalink radios [i.e. Inmarsat Satellite Communications (SATCOM), VHF, HF] and military tactical datalink radios [i.e. Military Strategic, Tactical and Relay (MILSTAR) SATCOM, Multifunction Information Distribution System (MIDS), Joint Tactical Information Distribution System (JTIDS)] are used.

Currently, the typical military aircraft is equipped with several independent communications systems. The aircraft crew must interface directly with each communications system and the integration of data link information between each system must be manually processed by the crew. Types of communication systems the crew must interact with are UHF/VHF line of sight radios, HF long-range radios, military satellite communications equipment, civil satellite communications equipment, and the JTIDS/MIDS communications equipment. As civil telecommunications technologies evolve, data link communications will continue to expand and the aircraft crew workload and efficiency make it necessary to integrate these disparate communication systems and automate more routine tasks at multiple locations using a diverse range of equipment.

Currently, each military tactical datalink radio system is operated independently of other civil or military systems. Exchange of information between systems is performed manually or not at all. The Civil Communications Management Unit (CMU) specified by Aeronautical Radio, Inc. (ARINC) specification number 758, integrates three civil datalink radio systems (Inmarsat SATCOM, VHF, and HF) but does not interface with any military datalink radio systems.

ARINC and Viasat demonstrated sending a military Link-16 message through the ACARS ground-based communications infrastructure. This was accomplished by using a Link-16 radio in an aircraft to communicate with a Link-16 radio installed in the ground-based communications infrastructure and then routing the link-16 message to its destination over phone lines. In actuality, they did not route the Link-16 message through another datalink radio system.

The Air Force Research Laboratory (AFRL) at Rome, NY installed several different datalink radio systems in a pallet and put the pallet in a KC-10 aircraft. The purpose of this demonstration was to receive multi-media information over several different air-ground networks while airborne. They did not route messages intended for one datalink system through another datalink system. Civil and military datalink systems operated independently from one another in this demonstration.

Each of these prior art systems are deficient because: communications management of military tactical networks (JTIDS, MIDS, and MILSTAR) is not integrated with civil networks (Inmarsat SATCOM, VHF, and HF); messages normally intended for transmission over a military tactical network can not be re-routed over one of several civil networks; messages normally intended for transmission over a civil network can not be re-routed over one of several military networks; message routing criteria based on priority, security, urgency, message size, and transmission bandwidth is not integrated for all available civil and military communications systems as a whole; data collection agents are not implemented to compute an integrated actual communications performance indicator; data collection agents are not used to collect mission data available from tactical datalink messages needed for Air Traffic Control (ATC) messages; and data collection agents are not used to collect mission data available from tactical datalink messages needed for Aeronautical Operational Control (AOC) messages.

None of the prior art systems creates a software or hardware solution that provides an intelligent bridge between disparate vehicle and ground-based communications systems.

### SUMMARY OF THE INVENTION (DISCLOSURE OF THE INVENTION)

SmartBridge will interface with tactical datalink applications and service support applications used by the military and manage associated transport, network, link, and physical layers needed to interface with the military communications systems (JTIDS, MIDS, and MILSTAR), and other avionics devices and end systems. Additionally, SmartBridge will offer the military the capability to bridge between military and civil communications systems allowing messages to be routed transparently across all available systems. For example, a Link-16 message could be routed over a civil VHF radio system in the event that the Link-16 radio is failed or unavailable. Likewise, the Link-16 tactical radio could be used to route ATC messages in the event that civil radio [Satellite Date Unit (SDU), VHF Data Radio (VDR), or High Frequency Data Radio (HFDR)] fail or are unavailable. For aircraft and spacecraft applications, the SmartBridge function can be implemented in a standalone hardware unit, or as a software application in an on-board computer system, that interfaces with onboard communications systems.

For surface vehicle applications, the SmartBridge function can be implemented in a standalone hardware unit, or as a software application in an on-board computer system, that interfaces with onboard communications systems. SmartBridge will provide enhanced communication network management onboard the vehicle along with data routing to other systems. Data collection agents can be used to extract information from internal equipment or extract information from other onboard messages for reporting.

For ground-based communications infrastructures, the SmartBridge function can be implemented as a software application in a computer system that interfaces with various communications networks. SmartBridge enables ground stations to interpret data from either civil or military datalink systems, and can provide a communications medium to decipher and route data to the respective ground network. This will enable military ground stations receiving data to handle civil communications messages or route data from military communications messages to civil ground networks.

By addressing all applications (aircraft, spacecraft, surface, and ground-based), the SmartBridge function can provide interfaces between military and civil communications systems and bring previously non-connected networks together for enhanced interactions. Additionally, communications networks requiring interaction with data in other stove-piped networks can use SmartBridge to perform advanced data routing to these disparate networks.

A primary objective of the present invention is to provide a method and apparatus for performing new and unique functions for the military integrating both civil and military communications requirements.

Another objective of the present invention is to make it easier for the military to get real-time data when they want it and where they want it.

Yet another objective of the present invention is to provide a system that integrates data link information within military aircraft avionics and ground vehicle computer architectures.

Another objective of the present invention is to provide a system to transmit and process a variety of different types of data link messages originating from or sent to disparate civil and military communication systems onboard an aircraft and ground vehicle as well as providing military interfaces to civil ground-based communications infrastructures.

Another objective of the present invention is the establishment of message routing instructions using common criteria for both military and civil messages.

A primary advantage of the present invention is to provide a system to manage the integration, configuration, and status of all available civil and military communications systems.

Another advantage of the present invention is the reduction of vehicle crew workload by integrating communications datalink equipment and automating message routing decisions.

Yet another advantage of the present invention is the improvement of the overall operational efficiency of the military through intelligent information management and message handling flexibility across all available communications networks.

Another advantage of the present invention is the ability of the system to be applied to information management and message handling for commercial transportation businesses (airlines, trucking, trains, ships, etc.) Yet another advantage of the present invention is the system's intelligent applications using learning techniques to improve the overall efficiency of integrated military missions, operations, and maintenance activities.

Other objectives, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objectives and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a system context diagram for the SmartBridge function.

FIGS. 2a and 2b are a two part flow chart illustrating the SmartBridge functional flow.

### DESCRIPTION OF THE PREFERRED EMBODIMENTS (BEST MODES FOR CARRYING OUT THE INVENTION)

The present invention creates a software or hardware solution that provides an intelligent bridge between disparate vehicle and ground-based communications systems.

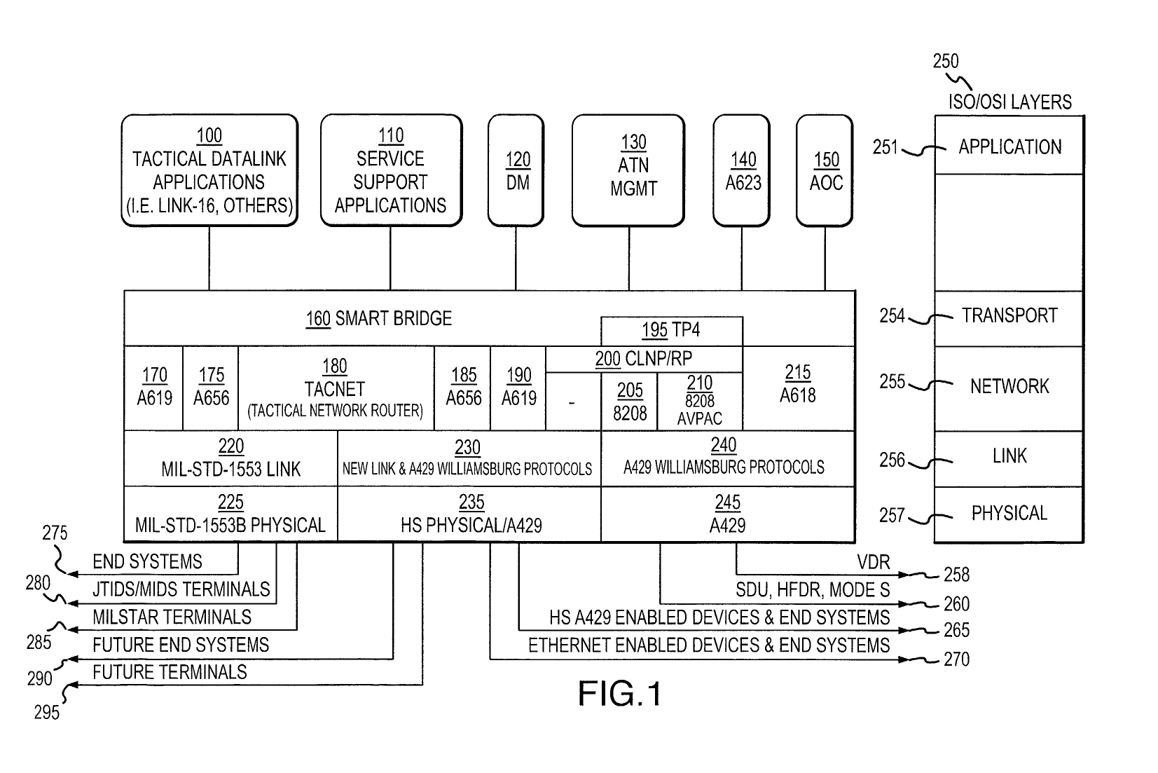

FIG. 1 illustrates how the SmartBridge function can fit into a layered architecture. In this context the SmartBridge function becomes an interface layer between applications (on top) and various network layers defined by the International Standards Organization (ISO) and Open Systems Interconnection (OSI) standard (i.e. transport, network, link, and physical) layers used to interface with different communications systems. With this layered architecture, the SmartBridge function can be implemented in systems on aircraft, spacecraft, and surface vehicles as well as in ground-based communications infrastructures to intelligently integrate each together into a global communications network.

As shown in FIG. 1, the SmartBridge 160 is layered with software applications 100, 110, 120,130,140, and 150 and functions 170 through 245, that can be executed in aircraft, spacecraft, surface vehicle, and ground-based computer systems. These software applications 100 through 150 and functions 170 through 245 are layered in accordance with the OSI Layers 250. The OSI standard defines seven layers as application 251, presentation (not shown), session (not shown), transport 254, network 255, link 256, and physical 257. Presentation and session layers are either not used or are incorporated by the software applications as required. External interfaces 258 through 295 are used by these software applications 100 through 150 and functions 170 through 245. These software applications 100 through 150 and functions 170 through 245 could be implemented in a stand-alone box (an example is defined in ARINC specification number 758) and execute on processors within this box. These same software applications 100 through 150 and functions 170 through 245 could also be executed in other computer equipment where processor resources and communications interface hardware is available.

One example of how SmartBridge 160 could be applied is to expand the data communications capabilities in today's military fighter aircraft. The current data communications capability of a fighter aircraft is designed for tactical operations and is very limited in its ability to use civil datalink air-ground communication networks. Fighter aircraft typically use the Link-16 radio system. The Link-16 radio system today only interfaces with military air-ground communications networks and only exchanges information with other military aircraft equipped with Link-16 radios and military command and control centers. Incorporating SmartBridge 160 into fighter aircraft will provide the capability to bridge between military and commercial air-ground communications networks. This will allow information on the fighter aircraft to be exchanged with commercial air-ground networks in addition to the military air-ground networks. This added capability will allow exchange of information with civil ATC centers as well as with other military organizations such as operational and maintenance organizations. To accomplish this, SmartBridge 160 and the civil communications management functions (120 through 150, 170,175,185 through 215, and 230 through 245) can be implemented as software layers within an existing mission computer on the fighter aircraft. Additional software layers can also be implemented in the mission computer to provide military unique software applications (100 and 110) and military unique functions (180, 220 and 225) that are associated with fighter aircraft datalink operations. The mission computer provides access to the external military interfaces on the fighter aircraft (275 through 285).

For this example it is assumed that the fighter aircraft does not contain any civil communications radios or end systems or the associated external interfaces (258 through 270) to the mission computer. It is also assumed that the fighter aircraft does not contain any future military end systems or the associated external interfaces (290 and 295) to the mission computer. SmartBridge 160 can support these civil radios and end systems and future military end systems if and when they are added to the fighter aircraft in the future.

Using this example, SmartBridge 160 provides the following capabilities to expand the data communications capabilities in today's military fighter aircraft:

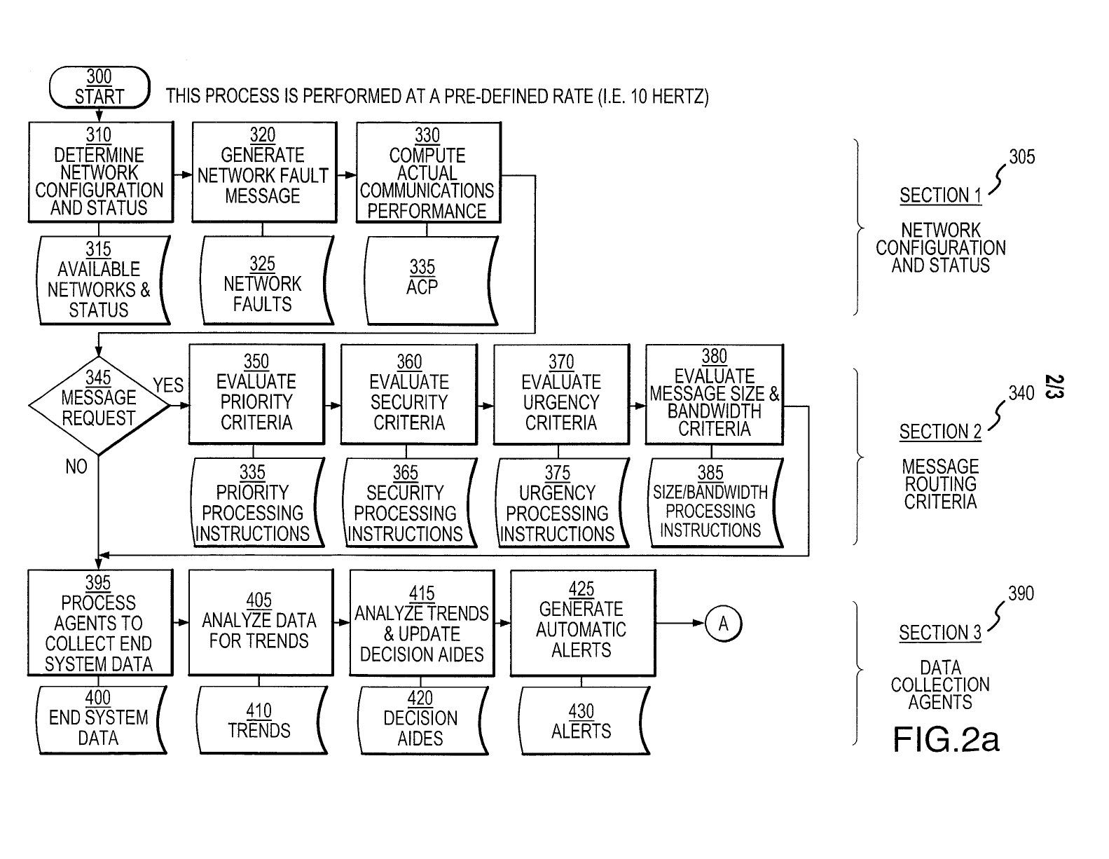

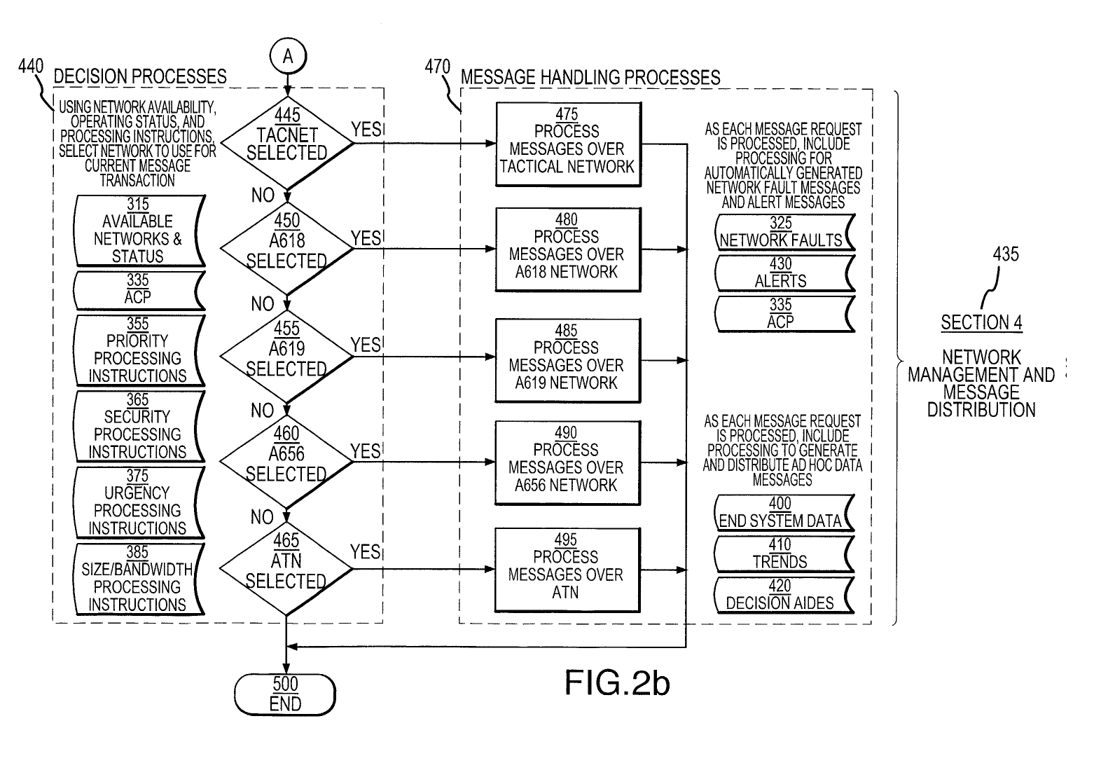

1. SmartBridge 160 determines which military end systems 275 are connected to the mission computer and the health of those end systems. SmartBridge 160 determines which military communications radios are connected to mission computer (280 and 285) and the health of those communications radios. By determining the type of radio (JTIDS, MIDS, or MILSTAR) SmartBridge 160 knows what communications network 180 to use and the link layer (220 or 230) and physical layer (225 or 235) protocols that will apply. SmartBridge 160 determines the status and performance capability of the available military radios and computes the Actual Communications Performance (ACP) indicator. The ACP and any network faults are recorded in memory to be used in making subsequent message routing decisions. This general process is illustrated in FIG. 2a 310 through 335.

2. SmartBridge 160 executes its data collection agents to monitor available end systems 275 on the fighter aircraft. These data collection agents also interface with military software applications 100 and 110 to collect tactical and mission data. In this example engine data and end system status and faults are collected from available end systems 275, and aircraft position and navigation data is collected from tactical datalink applications 100.

3. SmartBridge 160 analyzes the engine data and end systems status and faults looking for trends, maintenance decision aids, and alerts for the pilot. This general process is illustrated in FIG. 2a 395 through 430.

3. SmartBridge 160 sends the collected data to civil communications management applications 120 through 150 where they are formatted into an engine parameter report, maintenance data report and a position report. Civil communications management applications 120 through 150 also schedule the position report to be sent to the current ATC center, and the engine parameter report and maintenance data report are scheduled to be sent to the military AOC for the fighter aircraft. These scheduled reports are properly formatted to include the appropriate destination address and then sent to SmartBridge 160 to be transmitted over the available communications network.

4. SmartBridge 160 analyzes the type of reports to be sent and determines their routing criteria. Each individual report is processed according to its routing criteria and routing instructions are prepared. This general process is illustrated in FIG. 2a 345 through 385.

5. SmartBridge 160 uses the current network configuration and status information and message routing instructions to determine the exact message routing. For this example the JTIDS radio terminal 280 will be used to transmit the position report because it has a high priority. The MILSTAR radio terminal 285 is selected to transmit the engine parameter report and maintenance data report on a low priority basis. This general process is illustrated in FIG. 2b 445 through 495. SmartBridge 160 uses the appropriate network layer 180, link layer 220, and physical layer 225 to transmit each message to either the JTIDS radio terminal 280 or the MILSTAR radio terminal 285.

6. In this example the civil air-ground communications network on the ground contains a JTIDS compliant Link-16 radio terminal and receives the position report transmitted by the JTIDS Link-16 radio terminal on the fighter aircraft. The civil ground station equipment also contain SmartBridge 160 functions and civil communications management functions (120 through 150,170, 175, and 185 through 215) implemented as software layers and it's own link and physical layers. Using SmartBridge 160 functions and civil communications management functions (120 through 150, 170, 175, and 185 through 215), the civil ground station equipment determines that the position report is intended for the ATC center and sends it to the proper ATC system.

7. The engine parameter report and maintenance data report transmitted from the fighter aircraft's MILSTAR radio terminal is received by the MILSTAR communications system. The associated MILSTAR ground station equipment contain SmartBridge 160 functions and civil communications management functions (120 through 150, 170, 175, and 185 through 215) implemented as software layers and it's own link and physical layers. Using the SmartBridge 160 function and civil communications management functions (120 through 150, 170, 75, and 185 through 215), the MILSTAR ground station equipment determines that these reports are intended for the fighter aircraft AOC and send them to the proper military AOC system.

8. The same general process in reverse can be used on the fighter aircraft to receive incoming messages sent from the civil or military air-ground communications networks. In this case SmartBridge 160 receives messages from the available communications radios 280 and 285 and analyzes them to determine where to send them using instructions contained in each message. SmartBridge 160 sends civil messages, such as ATC or AOC messages, to the appropriate civil communications management software application 120 through 150. SmartBridge 160 sends military messages, such as Link-16 mission information, to the appropriate military software applications 100 and 110 or requested end systems 275 on the fighter aircraft. SmartBridge 160 also executes its data collection agents to monitor these incoming messages and collects information as required. SmartBridge 160 intelligently routes this collected information to software applications (100 through 150) and end systems 275. This fighter aircraft example illustrates how SmartBridge 160 processes and routes both civil messages (ATC and AOC) as well as military messages (Link-16 mission information) over the available JTIDS/MIDS radio terminals 280 and MILSTAR radio terminals 285. The fighter aircraft could contain a civil communications radio such as a VDR 258, or a SDU, HFDR or Mode S 260. In this case SmartBridge 160 would process and route both civil messages (ATC and AOC) as well as military messages (Link-16 mission information) over the available VDR 258 and SDU, HFDR or Mode S 260 as required.

The definitions and applications of the elements of FIG. 1 are described as follows.

Tactical datalink applications 100 (i.e., Link-16, others) represents military software applications that use and/or generate mission data that is received from and/or sent to other systems or over available datalink networks.

Service support applications 110 represent software applications that provide services and/or support to tactical datalink applications 100 and the SmartBridge function 160.

Datalink Management (DM) 120 represents software applications that provides datalink management for avionics end systems in accordance with ARINC specification number 656. DM 120 is a standard civil datalink application and is used only when an ARINC specification number 656 network path 185 is available.

ATN MGMT 130 represents software applications that provide ATN message management (MGMT) 130. This is an emerging civil datalink application that is currently being developed. These applications will use ATN protocol functions when available to interface with external civil communications equipment and other devices and end systems (258 through 270). These protocol functions are Transport Protocol 4 (TP4) 195, Connection Less Network Protocol/Router Protocol (CLNP/RP) 200, 8208 205, and 8208 Aviation Packet (AVPAC) 210 and associated link layers 230, 240 and physical layers 235, 245.

A623 140 represents software applications that generate ATC messages in accordance with ARINC specification number 623. A623 140 is a standard civil datalink application and is used when ARINC specification number 623 messages are required.

AOC 150 represents software applications that generate AOC messages in accordance with ARINC specification number 702A flight management system AOC and ARINC specification number 620. AOC 150 applications are standard civil datalink applications that interface with end systems and route these AOC messages to and from end systems and available communications equipment.

SmartBridge 160 processes transmit message requests received from each application (100 through 150) to determine the message routing criteria 340 of FIG. 2a and selection of the appropriate network path (170 through 215) to use in transmitting the message. SmartBridge 160 also processes messages received from each of the available network paths (170 through 215) using the message handling processes 470 of FIG. 2b, to determine which application (100 through 150) each received message is to be sent to. In this manner SmartBridge 160 manages the message routing decisions so that applications (100 through 150) do not need to be concerned about which network path to use.

An example of the benefit SmartBridge 160 provides to the military can be illustrated with the AOC 150 application. In the civil environment AOC messages only use the A618 215 network path or the ATN network path (195 through 210) for sending and receiving AOC messages using civil datalink radios 258, 260. SmartBridge 160 will also use the tactical network path 180 to send and receive AOC 150 messages. By using the tactical network path 180, SmartBridge 160 can send and receive AOC 150 messages using the JTIDS/MIDS datalink radio terminals 280 or the MILSTAR datalink radio terminals when they are available. SmartBridge 160 uses the necessary decision processes 440 and message handling processes 470 to format AOC messages for transmission over the selected network path and to decode AOC messages received over each network path. Since the SmartBridge function 160 is implemented in both the vehicle equipment as well as the ground systems equipment, these decision processes 440 and message handling processes 470 ensure that each message is properly handled and distributed to the intended application(s). The process used to handle AOC messages described in this example is the same process that will be used for the other applications (100 through 140).

TP4 195 represents software functions that implement the OSI transport layer protocols for the ATN network path. TP4 195 is defined by the International Civil Aviation Organization (ICAO) ATN specification.

A619 170, 190 represent software functions that implement the OSI network layer protocols for communications with end systems in accordance with ARINC specification number 619. A619 170 implements A619 protocols using Military Standard 1553B (MIL-STD-1553B) link 220 and physical 225 layers. A619 190 implements A619 protocols using ARINC 429 or Ethernet link 230 and physical 235 layers.

A656 175, 185 represent software functions that implement the OSI network layer protocols for communications with a flight management system in accordance with ARINC specification number 656. A656 175 implements A656 protocols using MIL-STD-1553B link 220 and physical 225 layers. A656 185 implements A656 protocols using ARINC 429 or Ethernet link 230 and physical 235 layers.

TACNET 180 (Tactical Network Router) represents software functions that implement the OSI network layer protocols for tactical networks. The TACNET 180 network layer protocols function 180 uses various link layers 220, 230 and physical layers 225, 235 to interface with the various military tactical communications systems and associated end systems 275 through 295.

CLNP/RP 200 represents software functions that implement part of the OSI network layer protocols for the ATN network path. CLNP/RP 200 is defined by the ICAO ATN specification.

Element 8208 205 represents software functions that implement part of the OSI network layer protocols for the ATN network path. 8208 205 is defined by the ICAO ATN specification.

Element 8208 AVPAC 210 represents software functions that implement part of the OSI network layer protocols for the ATN network path. Element 8208 AVPAC 210 is defined by the ICAO ATN specification.

A618 215 represents software functions that implement the OSI network layer protocols for communications with various air-ground networks in accordance with ARINC specification number 618.

MIL-STD-1553 LINK 220 represents software functions that implement the OSI link layer protocols for network paths that interface with equipment using MIL-STD-1553B interfaces.

MIL-STD-1553 PHYSICAL 225 represents software functions that implement the OSI physical layer protocols for communication with MIL-STD-1553B controllers.

NEW LINK & A429 WILLIAMSBURG PROTOCOLS 230 represents software functions that implement the OSI link layer protocols for network paths that interface with equipment using Ethernet or ARINC specification number 429 interfaces.

HS PHYSICAL/A429 235 represents software functions that implement the OSI physical layer protocols for communication with Ethernet controllers or ARINC specification number 429 High Speed (HS) controllers.

A429 WILLIAMSBURG PROTOCOLS 240 represents software functions that implement the OSI link layer protocols for network paths that will interface with equipment using standard ARINC specification number 429 interfaces.

A429 245 represents software functions that implement the OSI physical layer protocols for communication with standard ARINC specification number 429 controllers.

END SYSTEMS 275 represents interface systems that the SmartBridge function 160 will communicate with. FUTURE END SYSTEMS 290 represents growth for future systems that the SmartBridge function 160 will communicate with.

JTIDS/MIDS TERMINALS 280 represents JTIDS and MIDS radio terminal equipment that TACTICAL DATALINK APPLICATIONS 100, SERVICE SUPPORT APPLICATIONS 110, and military end systems 275, 290 communicate with.

MILSTAR TERMINAL 285 represents MILSTAR satellite radio terminal equipment that TACTICAL DATALINK APPLICATIONS 100, SERVICE SUPPORT APPLICATIONS 110, and military end systems 275, 290 communicate with.

VDR 258 represents civil VDR equipment that applications 100 through 150 and end systems 265, 270, 275 or 290 communicate with.

SDU, HFDR, MODE S 260 represents civil SDU equipment, HFDR equipment, or Mode S transponder equipment that applications 100 through 150 and end systems 265, 270, 275 or 290 communicate with.

HS A429 ENABLED DEVICES & END SYSTEMS 265 represents equipment that applications 100 through 150 communicate with that are connected to ARINC specification number 429 HS system buses.

ETHERNET ENABLED DEVICES & END SYSTEMS 270 represents equipment that applications 100 through 150 communicate with that are connected to ethernet system buses.

FIG. 2 illustrates the SmartBridge functional flow in FIG. 2a and FIG. 2b, and is organized into four major sections:

Network Configuration and Status 305,

Message Routing Criteria 340,

Data Collection Agents 390, and

Network Management and Message Distribution 435.

START 300 illustrates the beginning of the functional flow. SmartBridge processes being described are repetitive and will be executed at a pre-defined rate.

Section 1 305 illustrates the NETWORK CONFIGURATION AND STATUS function. DETERMINE NETWORK CONFIGURATION AND STATUS 310 interfaces with all available civil and military communications systems to determine their configuration and operational status. The results are then placed as stored data in AVAILABLE NETWORKS & STATUS 315. GENERATE NETWORK FAULT MESSAGE 320 uses information received from each communications network to identify communications system faults and updates NETWORK FAULTS 325 with current fault status. Using AVAILABLE NETWORKS & STATUS 315 and NETWORK FAULTS 325, COMPUTE ACTUAL COMMUNICATIONS PERFORMANCE 330 assesses overall capability and health of available communications systems and computes a current ACP indicator and updates ACP 335 with results.

Section 2 340 illustrates the MESSAGE ROUTING CRITERIA function. MESSAGE REQUEST 345 determines if a request has been submitted to receive or transmit a message. If a request is active, then several processes 350, 360, 370, and 380 are performed to evaluate routing criteria and to prepare instructions for the NETWORK MANAGEMENT AND MESSAGE DISTRIBUTION function in section 4 435. EVALUATE PRIORITY CRITERIA 350 assesses message priority constraints and updates PRIORITY PROCESSING INSTRUCTIONS 355 with routing instructions. EVALUATE SECURITY CRITERIA 360 assesses message security constraints and updates SECURITY PROCESSING INSTRUCTIONS 365 with routing instructions. EVALUATE URGENCY CRITERIA 370 assesses message urgency constraints and updates URGENCY PROCESSING INSTRUCTIONS 375 with routing instructions. EVALUATE SIZE/BANDWIDTH CRITERIA 380 assesses message size and bandwidth constraints and updates SIZE/BANDWIDTH PROCESSING INSTRUCTIONS 385 with routing instructions.

Section 3 390 illustrates the DATA COLLECTION AGENTS function as a series of processes 395, 405, 415, and 425. PROCESS AGENTS TO COLLECT END SYSTEM DATA 395 scans messages received from various end systems interfaced to the SmartBridge function 160 and extracts data of interest. Data extracted is saved in END SYSTEM DATA 400. ANALYZE DATA FOR TRENDS 405 scans current values of END SYSTEM DATA 400 with previous values collected over a selectable time interval and identifies trends for specific data items, for example engine parameter trend data. Any trends of significance are saved in TRENDS 410. ANALYZE TRENDS & UPDATE DECISION AIDES 415 scans trend values in TRENDS 410 and evaluates threshold criteria established for decision points. DECISION AIDES 420 is updated with results from this analysis. GENERATE AUTOMATIC ALERTS 425 evaluates decision aides and generates alerts (saved ALERTS 430) to be distributed to pre-defined military agencies and organizations.

Section 4 435 illustrates the NETWORK MANAGEMENT AND MESSAGE DISTRIBUTION function. It is divided into two parts, DECISION PROCESSES 440 used to determine available communications networks that will be used and MESSAGE HANDLING PROCESSES 470 used to send and receive messages over available communications networks.

The decisions 445, 450, 455, 460 and 465 made in DECISION PROCESSES 440 use information saved in AVAILABLE NETWORKS & STATUS 315, ACP 335, PRIORITY PROCESSING INSTRUCTIONS 355, SECURITY PROCESSING INSTRUCTIONS 365, URGENCY PROCESSING INSTRUCTIONS 375, and SIZE/BANDWIDTH PROCESSING INSTRUCTIONS 385. These stored data items are used to select networks to be used for current requested message transactions.

TACNET SELECTED 445 determines availability of and criteria for using military tactical networks (examples are JTIDS, MIDS, MILSTAR, or others) using TACNET network layer protocols 180.

A618 SELECTED 450 determines availability of and criteria for using various civil air-ground networks 258 and 260 of FIG. 1, in accordance with protocols defined by ARINC specification number 618 215 of FIG. 1.

A619 SELECTED 455 determines availability of and criteria for communicating with various civil end systems 265 and 270 of FIG. 1, in accordance with protocols defined by ARINC specification number 619, 170, 190 of FIG. 1.

A656 SELECTED 460 determines availability of and criteria for communicating with a flight management system using interfaces 265 or 270 of FIG. 1, in accordance with protocols defined by ARINC specification number 656 175,185 of FIG. 1.

ATN SELECTED 465 determines availability of and criteria for using various civil air-ground networks 258 and 260 of FIG. 1 in accordance with protocols defined by the ICAO ATN specification 195 through 210 of FIG. 1.

Processes 475, 480, 485, 490, and 495 performed in MESSAGE HANDLING PROCESSES 470 use information saved in stored data 325, 335, 400, 410, 420, and 430. NETWORK FAULTS 325, ALERTS 430 and ACP 335 are used to automatically generate ad hoc messages reporting network faults , alerts and the overall communications performance capability. END SYSTEM DATA 400, TRENDS 410 and DECISION AIDES 420 are used to automatically generate ad hoc messages distributing this information to appropriate military agencies and/or organizations.

PROCESS MESSAGES OVER TACTICAL NETWORK 475 performs network management and message handling for available military tactical networks JTIDS/MIDS 280, MILSTAR 285 or others 295 of FIG. 1.

PROCESS MESSAGES OVER A618 NETWORK 480 performs network management and message handling for available civil air-ground networks such as VDR 258, SDU 260, HFDR 260, MODE S 260 or others of FIG. 1, in accordance with protocols defined by ARINC specification number 618.

PROCESS MESSAGES OVER A619 NETWORK 485 performs network management and message handling for end systems 265, 270, 275 and 290 of FIG. 1, in accordance with protocols defined by ARINC specification number 619.

PROCESS MESSAGES OVER A656 NETWORK 490 performs network management and message handling for a flight management system in accordance with protocols defined by ARINC specification number 656.

PROCESS MESSAGES OVER ATN 495 performs network management and message handling for available civil air-ground networks such as VDR 258, SDU 260, HFDR 260, MODE S 260, or others of FIG. 1 in accordance with protocols defined by the ICAO ATN specification.

Major SmartBridge capabilities are Network Configuration and Status 305, Message Routing Criteria 340, Data Collection Agents 390, and Network Management and Message Distribution 435.

The process flow for Section 1 determining available network configuration and status 305 is illustrated in FIG. 2a. SmartBridge will receive datalink network status from both military and civil communications equipment in the form of digital data words. SmartBridge will also receive datalink network configuration information from both military and civil communications equipment in the form of digital data words. SmartBridge will use this data for building an integrated status of available communication devices along with their configuration and capabilities for use in intelligent routing that will reduce crew workload and increase the end-to-end message delivery success. Health monitoring functions of SmartBridge will record and alert the crew of any faults detected from connected communications systems. Loss of connections will result in an alert to the crew along with an outgoing message over another available communication system informing the ground or other vehicles of the communications downgrade. SmartBridge will also use this data to compute an ACP 335 indicator for the vehicle. With SmartBridge's understanding of the entire network configuration, it will be able to route outgoing messages over various networks using criteria built into message format or general downlink message conditions. Based on the network configuration, SmartBridge will differentiate between a secure and non-secure network and a military and non-military network, providing more robustness in message handling. SmartBridge will provide the conduit for uplink messages to military specific onboard applications 100,110, 275 and 290 and civil applications 120, 130, 140, 150, 265 and 270 of FIG. 1. This will allow datalink messages from ground-based communications infrastructures or other vehicles using the supported communications systems to be routed to supported applications (examples are a Link-16 message, secure ACARS message for military use, or a civil ATC clearance message).

The process flow for section 2 or determining message routing criteria 340 is illustrated in FIG. 2a. SmartBridge will analyze routing criteria against datalink messages to determine proper message handling responses. Output of the criteria evaluation will be used to route messages to particular communications systems or other equipment on the vehicle or in the ground-based communications infrastructure. SmartBridge will evaluate various routing criteria associated with each message based upon construction of each message. Based upon results of criteria analysis, SmartBridge will execute routing operations to transmit messages to particular communications systems that can best achieve end results of getting messages to intended destinations, while at the same time meeting routing criteria requirements. The following list and descriptions are examples of integrated routing criteria that SmartBridge will use on datalink messages:

Priority 350—SmartBridge will control message routing inside the system for all available networks. It will have the ability to prioritize messages scheduled for transmission. SmartBridge will differentiate message priority by definition of message requests and subsequently place messages ahead of or behind other messages to achieve desired operations. Prioritization will be established for each available network, as well as across all networks.

Security 360—SmartBridge will be able to format and route messages to networks that provide both secure and non-secure communications. Messages will contain data that identify whether or not messages should go over a secure datalink path.

Urgency 370—SmartBridge will recognize urgency flags that are contained in messages. SmartBridge will recognize various levels of urgency and respond accordingly by routing messages over the most reliable datalink, moving messages ahead of other messages and adding formats to messages so receiving systems understand the level of urgency.

Size 380—SmartBridge will recognize size of messages and route to the most efficient and cost-effective communications system. An example is that it is more cost-effective to transmit a large message over a VHF or HF link rather than a SATCOM link. Based on other routing criteria such as urgency, these large messages will be stored until a more cost-effective link is available and then transmitted at that time.

Bandwidth 380—Due to varying communications systems and varying transmission speeds, SmartBridge will route to particular systems based on bandwidth requirements that are contained in messages. Data will be included in messages to inform SmartBridge what bandwidth is acceptable to use for its routing decision making.

The process flow for section 3 or executing data collection agents 390 is illustrated in FIG. 2a. SmartBridge will execute software algorithms that process incoming and outgoing messages to identify selected information to automatically formulate message and distribution instructions. Data collection agents will collect end system data from all available sources 395, analyze the data for trends 405, analyze any trends to determine decision aides 415, and generate automatic alerts 425. In addition, equipment health data and mission data available from tactical datalinks and end systems will be collected. SmartBridge uses this data to automatically generate ATC messages per ARINC specification number 623 and RTCA DO-219, and AOC messages in accordance with ARINC specification numbers 620 and 702A. This data will also be used to prepare military unique AOC messages for command and control operations as well as for maintenance organizations. Table 1 provides an example list of automatically generated messages.

TABLE 1
Automatically Generated AOC and ATC Messages

| AOC Messages | ATC MESSAGES |
|---|---|
| Position Reports—Trigger Based | Position Reports—Trigger Based |
| Engine Parameter Report | Flight Plan Diversions due to |
| | Weather, Traffic |
| Maintenance Data Report | Altitude Clearances |
| Weapon Inventory Report | Air Traffic Information Service (ATIS) |
| | Reports based on Position downlink |
| Fuel Report | |
| Target Information Uplink | |
| Mission Route Modification | |
| System Performance Indicator | |

The process flow for section 4 or Network Management and Message Distribution 435 is illustrated in FIG. 2b. SmartBridge will use network configuration and status information 315, ACP 335, and various processing instructions 355, 365, 375 and 385 to manage operation of the available communications networks and make decisions on which active network to use for each specific message request. As each message request is being processed on a specific network, SmartBridge prepares ad hoc messages 470 using data collected by data collection agents 390. These automatically generated messages 470 will then be sent out over active networks using pre-defined message routing criteria 340 and 440. SmartBridge will also be capable of formatting each message in a number of different ways (using network protocols 170 through 215), so receiving communications systems or end systems can understand and use the data. The following list and descriptions are network routing destinations that SmartBridge will interface with for delivering messages.

TACNET—When messages are transmitted over any supported military tactical network, SmartBridge will route messages to the Tactical Network layer 180. This layer understands how to interface with these networks, allowing data to be transmitted to particular devices. SmartBridge provides specific destination system instructions based on routing criteria in the message and provides this information to the TACNET function 180.

A618—SmartBridge will route messages to the A618 network layer 215 upon evaluation of message content against routing criteria. This is used to route messages over civil communications systems. Secure messages can also be routed to this layer for use with compatible secure ACARS communications systems. Depending on the message routing criteria, this civil datalink connection can be used for military messages created by the onboard military applications 100, 110, 275 and 290.

A619—SmartBridge will route messages to other on board end systems by evaluating message criteria and forwarding to the A619 network layer 170 or 190. This is used when another system on the vehicle uses information received in uplink messages from the ground or other vehicles.

A656—SmartBridge will route messages to the A656 network layer 175 or 185 upon evaluation of message content against routing criteria. This will consist of data received in uplink messages that SmartBridge provides to a flight management system.

ATN—SmartBridge interfaces with ATN applications to handle those message requests. SmartBridge will route any ATN type message from a military or civil ATN application to the required communications system.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. A method of integrating multiple military and civil data link networks, and automatically selecting one of the available networks, and then routing a message to the selected data link, the method comprising the steps of:
a) providing at least one data link network, each data link network comprising a means to transmit and receive civil and military messages;
b) sending and receiving the message through a physical interface between communication data link equipment and a host computer;
c) formatting the message for delivery to or from the selected data link network; and
d) routing the message to or from the selected data link network based on dynamic routing criteria.

2. The method of claim 1 further comprising the step of translating civil data link network messages into military data link network formats and translating military data link network messages into civil data link network formats.

3. The method of claim 1 further comprising the step of extracting information from the civil and military messages for use in constructing ad hoc messages.

4. The method of claim 3 wherein the ad hoc messages comprises civil air traffic control information.

5. The method of claim 1 wherein the dynamic routing criteria comprise priority, security, urgency, size and bandwidth.

6. The method of claim 1 wherein the step of routing the message to or from the selected data link network comprises routing the message to an alternate data link network if the selected data link network malfunctions.

7. The method of claim 1 further comprising the step of determining a number of available data link networks, a type of each available data link network, and a working status of each available data link network.

8. The method of claim 7 further comprising the step of computing a single communication performance indicator for the available data link networks.

9. The method of claim 7 further comprising the step of constructing and transmitting a communication status message that comprises the computed communication performance indicator.

10. A method of integrating multiple military and civil end systems, and automatically transmitting messages to each end system and receiving messages from each end system, the method comprising the steps of:
a) transmitting and receiving the messages through a physical interface between an end system apparatus and a host computer;
b) formatting the messages for delivery to or from a selected end system apparatus; and
c) routing the messages to or from the selected end system based on dynamic routing criteria.

11. The method of claim 10 further comprising the step of translating civil end system messages into military end system message formats and translating military end system messages into civil end system message formats.

12. The method of claim 10 further comprising the step of extracting information from each end system message for use in constructing an ad hoc message.

13. The method of claim 12 wherein the ad hoc message comprises operational control and maintenance information.

14. The method of claim 12 further comprising the step of analyzing the extracted information from each end system message to determine trend information over a predefined time period.

15. The method of claim 14 further comprising the step of constructing a trend message.

16. The method of claim 14 further comprising the step of computing alerts and decision aides from the extracted information based upon predefined criteria.

17. The method of claim 16 further comprising the step of constructing an alert and decision aide message.

18. The method of claim 10 wherein the dynamic routing criteria comprise priority, security, urgency, size and bandwidth.

19. The method of claim 10 further comprising the step of determining a number of available end systems, a type of each available end system, and a working status of each available end system.

20. The method of claim 19 further comprising the step of computing a single system performance indicator for the available end systems.

21. The method of claim 19 further comprising the step of constructing and transmitting a computed system performance indicator message.

22. An apparatus for integrating military and civil data link networks and automatically selecting and routing a message to a selected data link, the apparatus comprising:
at least one data link, each data link comprising a means to transmit and receive civil and military messages;
a physical interface between communication data link equipment and a host computer for sending and receiving the message;
a means for formatting the message for delivery to or from the selected data link; and
a router for routing the message to or from the selected data link based on dynamic routing criteria./
